(19) United States
(12) Patent Application Publication
(10) Pub. No.: US 2017/0138807 A1
(43) Pub. Date: May 18, 2017

(54) METHOD OF MEASURING MOTION POWER AND RESISTANCE COEFFICIENT OF BICYCLE

(71) Applicant: NCKU RESEARCH AND DEVELOPMENT FOUNDATION, TAINAN CITY (TW)

(72) Inventors: JIUN-JIH MIAU, TAINAN CITY (TW); SHAU-SHIUN JAN, TAINAN CITY (TW); SYH-TSANG JENG, TAINAN CITY (TW); CHIH-CHUNG HU, TAINAN CITY (TW); HSI WONG, TAINAN CITY (TW)

(21) Appl. No.: 14/944,458

(22) Filed: Nov. 18, 2015

(51) Int. Cl. G01L 5/16; G01L 3/24; G01N 19/02

(52) U.S. Cl. CPC G01L 5/16; G01N 19/02; G01L 3/247

(57) ABSTRACT

A method of measuring motion power and resistance coefficient of a bicycle measures sensed data including at least one front projecting area of a bicycle ridden by a user, an air temperature value, an air pressure value, a traveling speed value, an acceleration value, a relative wind speed value, an inclination value and a total weight value to calculate an air resistance coefficient, a rolling friction coefficient of a bicycle tire, a force and a motion power applied to the bicycle by the user, so that the user may learn a better riding posture for different riding conditions and reduce the air resistance effectively by adjusting the riding posture, so as to reduce the consumed motion power. Through the installation of a display unit, the user may know about the data sensed by the sensor and the computation result of the processing unit anytime.

### FIELD OF THE INVENTION

The present invention relates to a method of measuring the motion power and resistance coefficient of a bicycle, in particular to the method of computing the air resistance coefficient while a user is riding a bicycle, the rolling friction coefficient of a bicycle tire, the force applied by the user to the bicycle, and the motion power of the user by means of sensed data.

### BACKGROUND OF THE INVENTION

Bicycle is a common short-distance transportation means in our daily life. In particular, people pay much more attention to the issues of environmental protection in recent years, and different countries promote the concept of power saving and carbon reduction and the widespread use of the bicycle as a transportation means to reduce energy consumption. In addition, surveys find growing emphasis on sports and fitness exercises, and bicycle riding has become a popular sport and is listed as one of the major competitions.

However, bicycle riding requires a user to step on the pedals of a bicycle to drive the wheels of the bicycle to move forward. Main resistance forces occurred in the bicycle riding process include the air resistance formed at the projecting area in the traveling direction of the user and the bicycle, the friction force between the moving bicycle and the ground, and the componential force of the gravitational force in a direction opposite to the traveling direction of the bicycle when riding uphill. The aforementioned resistance forces increase the user's burden of riding the bicycle. Obviously, it is necessary to analyze the sources of the resistance forces one by one, so that the user can overcome or reduce the resistance forces to improve the efficiency of riding the bicycle.

As disclosed in Taiwan Patent No. 1391281, entitled “Apparatus for measuring a total force with respect to a moving vehicle and a method using the same”, the method measures a change of speed, slope data, an atmospheric pressure and air temperature data to estimate an air density, a relative wind speed, and a total weight of the vehicle and a rider, an aerodynamic resistance and an area combined with an aerodynamic pressure to measure and calculate data including an aerodynamic force and a friction force between the bicycle and the ground, so as to measure a total force of the bicycle. However, the Taiwan Patent No. 1391281 just discloses how to measure the aerodynamic force and the friction force only, but it cannot measure an air resistance coefficient. The air resistance coefficient is an important parameter that affects the aerodynamic resistance, so that the actual aerodynamic resistance value cannot be calculated by the area, air density and relative wind speed if the air resistance coefficient cannot be calculated. As a result, related data including the total force of riding the bicycle and the consumed motion power cannot be obtained quickly.

In view of the problems of the prior art, the inventor of the present invention based on years of experience in the related industry to conduct extensive researches and experiments to measure the motion power and the resistance coefficient of riding a bicycle, and finally invented the method of the present invention to overcome the problems of the prior art.

### SUMMARY OF THE INVENTION

In view of the aforementioned drawbacks of prior art, it is a primary objective of the present invention to overcome the drawbacks of the prior art which cannot accurately measure related data including the air resistance coefficient of riding a bicycle, the total force of riding the bicycle, the consumed motion power, etc.

To achieve the aforementioned objective, the present invention provides a method of measuring motion power and resistance coefficient of a bicycle, and the method comprises the steps of: connecting a sensor to a processing unit of a computing means, and the sensor measuring or inputting a plurality of sensed data to be transmitted to the processing unit, and the sensed data including: at least one front projecting area A of a bicycle ridden by a user, an air density value ρ, a traveling speed value V and an acceleration value a of the bicycle, a relative wind speed value V_{w} while the bicycle is traveling, an inclination value θ of a road surface where the bicycle is ridden, and a total weight value m of the bicycle and the user; and fixing one of the front projecting areas A, and calculating the air resistance coefficient C_{d} and a rolling friction coefficient C_{F}(V) of the bicycle tire by substituting the sensed data into Equation 1 through the processing unit, provided that the user has not applied a force to the bicycle and the bicycle slides naturally, such that a change of the traveling speed value V measured by the sensor occurs and assumed that an air resistance coefficient C_{d} is as constant.

$${C}_{F} ( V ) mg cos θ + \frac{ρ {V}_{w}^{2} \cdot A \cdot {C}_{d}}{2} + mg sin θ = ma , \qquad ( Equation 1 )$$

where g is a gravitational acceleration value.

In a preferred embodiment, the front projecting area A is obtained by installing a wearing means including a position sensing means of the sensor on a user wherein each position sensing means is provided for sensing a position measuring value corresponsive to the front projecting area, and using the wearing means to sense the position measuring value by the position sensing means.

In the method of measuring motion power and resistance coefficient of a bicycle in accordance with the present invention, the wearing means is a bicycle helmet.

In another preferred embodiment, the sensor comprises an image capturing means installed at a front end of the bicycle for capturing a front-viewing image of the user and the bicycle, and the processing unit calculates the front projecting area.

The method of measuring motion power and resistance coefficient of a bicycle in accordance with the present invention further comprises the step of calculating a force fₐ applied to the bicycle by the user through the processing unit by Equation 2, provided that the user has applied the force to the bicycle.

$${f}_{a} + {C}_{F} ( V ) mg cos θ + \frac{ρ {V}_{w}^{2} \cdot A \cdot {C}_{d}}{2} + mg sin θ = ma \qquad ( Equation 2 )$$

The method of measuring motion power and resistance coefficient of a bicycle in accordance with the present invention further comprises the step of calculating a user's motion power by the product of the force fₐ applied to the bicycle by the user and the traveling speed value V through the processing unit.

The method of measuring motion power and resistance coefficient of a bicycle in accordance with the present invention further comprises the steps of installing a position sensing means included in the sensor through a wearing means, wherein a position measuring value sensed by each position sensing means is corresponsive to the respective front projecting area; and obtaining the front projecting area by the position measuring value sensed by the position sensing means provided that the user is wearing the wearing means.

In the method of measuring motion power and resistance coefficient of a bicycle in accordance with the present invention, the sensor further comprises a temperature measuring unit and a pressure measuring unit for measuring or inputting the sensed data including an air temperature value and an air pressure value, and the processing unit calculates the air density value by the air temperature value and the air pressure value.

In the method of measuring motion power and resistance coefficient of a bicycle in accordance with the present invention, the sensor further comprises a speed sensor, an anemometer and a level meter, and the speed sensor is provided for measuring the traveling speed value and the acceleration value, and the anemometer is provided for measuring the relative wind speed value, and the level meter is provided for measuring the inclination value.

In the method of measuring motion power and resistance coefficient of a bicycle in accordance with the present invention, the sensor is connected to the computing means through Bluetooth, Bluetooth Low Energy (BLE), Global System for Mobile Communications (GSM), Wireless Fidelity (WiFi) or ANT+ wireless communication.

In the method of measuring motion power and resistance coefficient of a bicycle in accordance with the present invention, the computing means further comprises a display unit and a storage unit, and the display unit and the storage unit are coupled to the processing unit, and the display unit is provided for displaying the data sensed by the sensor and the computation result of the processing unit, and the storage unit is provided for storing the data sensed by the sensor and the computation result of the processing unit at each time point.

In summation of the description above, the present invention has the following advantages and effects:

The present invention is capable of calculating the air resistance coefficient C_{d} of a bicycle and a rider and the rolling friction coefficient C_{F}(V) of a bicycle tire quickly by measuring or inputting the sensed data, provided that the user has not applied a force to the bicycle and the bicycle slides naturally, such that a change of the traveling speed value V measured by the sensor occurs and assumed that an air resistance coefficient C_{d} is as constant, and further calculating the force fₐ applied to the bicycle by the user and the motion power of the user, so that the user may know about the sensed data and the computation result of the processing unit and adjust the riding posture to reduce the resistance force, so as to improve the efficiency of riding the bicycle.

### BRIEF DESCRIPTION OF THE DRAWINGS

FIG. 1 is a flow chart the present invention;

FIG. 2 is a schematic view of the structure of the present invention;

FIG. 3 is a schematic view of a using status of the present invention being installed to a bicycle; and

FIG. 4 is a schematic view of a using status of the present invention with a computing means installed at a front end of a bicycle.

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

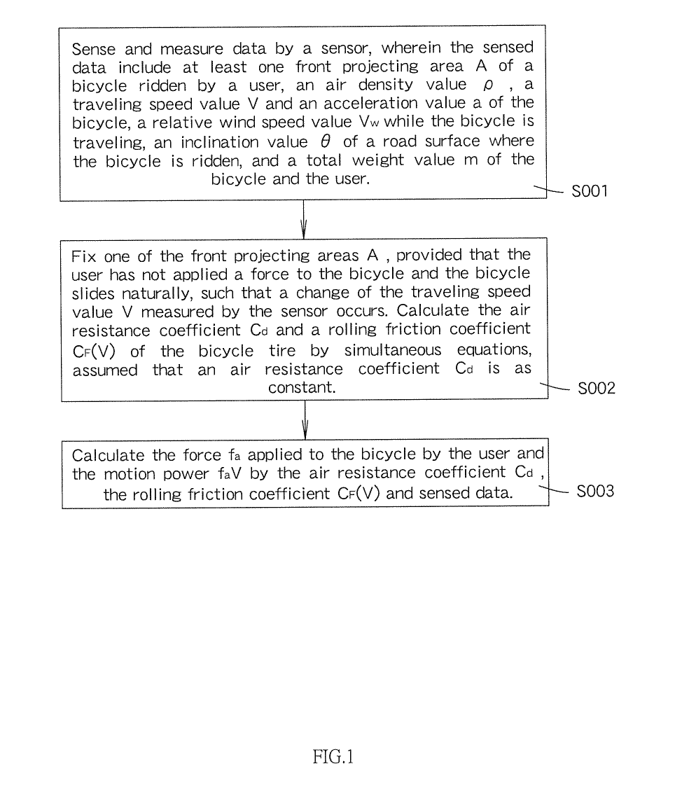

With reference to FIG. 1 for the flow chart of a method of measuring a motion power and a resistance coefficient of a bicycle in accordance with the present invention, the method comprises the following steps:

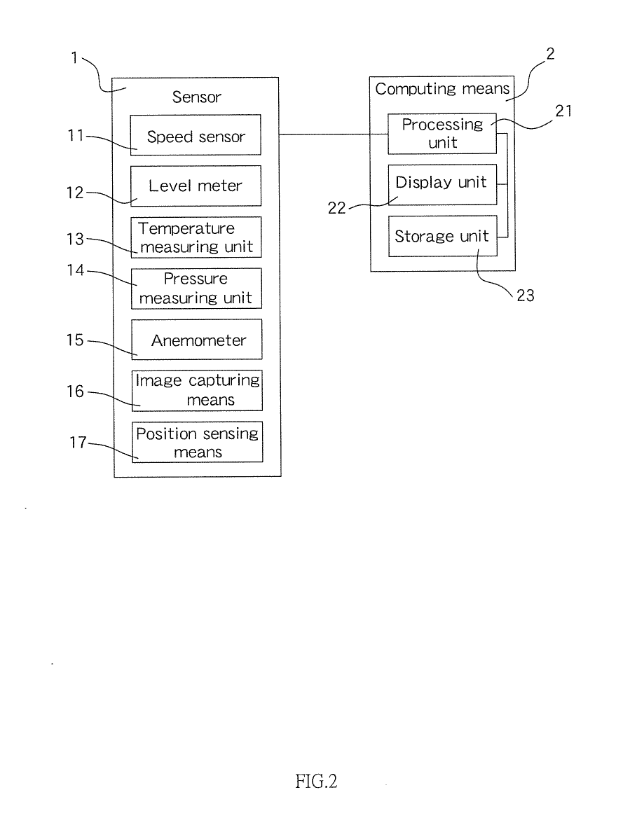

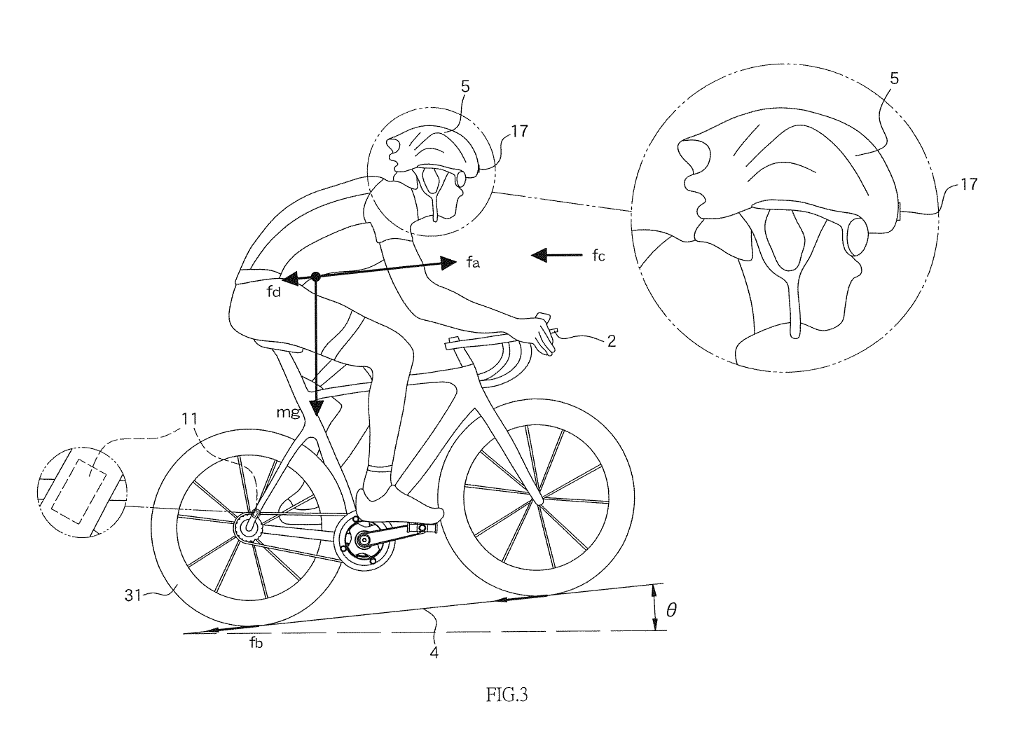

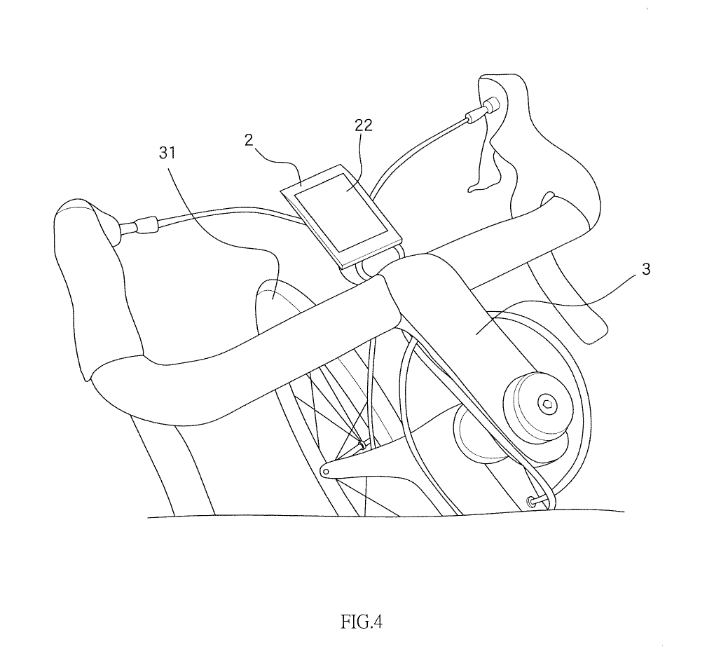

S001: Connect a sensor 1 to a processing unit 21 of a computing means 2 as shown in FIG. 2, wherein the sensor 1 measures or inputs a plurality of sensed data to be transmitted to the processing unit 21. In FIGS. 3 and 4, the sensor 1 may be installed at an appropriate position of a bicycle 3 according to the desired measuring values, and the computing means 2 may be installed at any convenient position of the bicycle 3. In this embodiment, the computing means 2 is installed at a front end of the bicycle 3. The sensed data include at least one front projecting area A of the bicycle 3 ridden by a user, an air density value ρ, a traveling speed value V and an acceleration value a of the bicycle 3, a relative wind speed value V_{w} while the bicycle 3 is traveling, an inclination value θ of a road surface 4 where the bicycle 4 is ridden, and a total weight value m of the bicycle 3 and the user. In FIG. 3, the equation of the motion of the bicycle 3 is defined according to Newton's Second Law of Motion, and the total force F_{T} of the bicycle 3 ridden by the user includes a force fₐ applied to the bicycle 3 by the user, a friction force f_{b} between the wheels of the bicycle 3 and the ground, an air resistance f_{c} produced during the process of riding the bicycle 3, a componential force f_{d} of the gravitational force of the bicycle 3 and the user along the traveling direction of the bicycle 3. The total force F_{T} is expressed in the Mathematical Equation 1 below:

F_{T}=fₐ+f_{b}+f_{c}f_{d}=ma (Mathematical Equation 1)

Where, the total weight value m of the bicycle 3 and the user may be inputted into the processing unit 21 of the computing means 2 by the user directly, and the acceleration value a is obtained by measuring a traveling speed value V by a speed sensor 11 installed in the sensor 1 and computing a change of the traveling speed value V per unit time. Wherein, the speed sensor 11 may be installed at a tire 31 of the bicycle 3 as shown in FIG. 3, and the traveling speed value V can be computed by the conversion of the rotation speed of the tire 31, but the present invention is not limited to such arrangement only. In another preferred embodiment, an acceleration meter is used for measuring an acceleration value a.

The friction force f_{b} of the bicycle 3 with respect to the ground is calculated by the Mathematical Equation 2 below:

f_{b}=C_{F}mg cos θ (Mathematical Equation 2)

Where, C_{F} is the rolling friction coefficient of the tire 31 of the bicycle 3, g is the gravitational acceleration, θ is the inclination value of the road surface 4 where the bicycle 3 is ridden and which is measured by a level meter 12 installed in the sensor 1. In a preferred embodiment, the level meter 12 may be integrated into the computing means 2. The rolling friction coefficient C_{F} may be a function of the traveling speed value V of the bicycle 3 provided that the conditions of the road surface 4 and the tire 31 remain unchanged, so that the rolling friction coefficient C_{F} may be expressed as C_{F}(V), and the rolling friction coefficient C_{F} is actually affected by the traveling speed value V as well as a tire pressure Pₜ of the tire 31, a contact area A_{f} between the tire 31 and the road surface 4, and the road surface condition (such as a dry road surface, a wet road surface, and the material of the road surface) R_{f}, so that the rolling friction coefficient C_{F} may also be expressed as C_{F}(V, Pₜ, A_{f}, R_{f}). Provided that the user's riding habit and route, the tire pressure Pₜ, the contact area A_{f} and the road surface condition R_{f} are constants, the rolling friction coefficient C_{F} may be simplified and expressed as C_{F}(V), and the numerical value of the gravitational acceleration g may be written into the processing unit 21 without the need of taking the measurement.

The air resistance f_{c} produced during the traveling process of the bicycle 3 is expressed in the Mathematical Equation 3 below:

$${f}_{c} = \frac{ρ {V}_{w}^{2} \cdot A \cdot {C}_{d}}{2} \qquad ( Mathematical Equation 3 )$$

where, ρ is the air density value, V_{w} is the relative wind speed value while the bicycle 3 is traveling, A is the front projecting area of the bicycle 3 ridden by the user, and C_{d} is the air resistance coefficient. The air density value ρ may be inputted into the processing unit 21 by the user. In this preferred embodiment, the sensor 1 includes a temperature measuring unit 13 and a pressure measuring unit 14 for measuring or inputting sensed data including an air temperature value and an air pressure value, so that the processing unit 21 may calculate the air density value ρ by a gas equation (such as the ideal gas equation). In a preferred embodiment, the temperature measuring unit 13 and the pressure measuring unit 14 are integrated directly into the computing means 2.

The relative wind speed value V_{w} is measured by an anemometer 15 included in the sensor 1. In a preferred embodiment, the anemometer 15 is substantially windmill shaped and installed at a front end of the bicycle 3, and the anemometer 15 is also integrated into the computing means 2.

As to the calculation of the front projecting area A of a bicycle 3 ridden by a user, the sensor 1 of a preferred embodiment, sensor 1 further comprises an image capturing means 16 installed at a front end of bicycle 3 for capturing a front-viewing image of the user and the bicycle 3, and the processing unit 21 is provided for calculating the front projecting area. In this preferred embodiment, a position sensing means 17 included in the sensor 1 is installed to a wearing means 5, wherein the wearing means 5 may be a helmet of a bicycle 3 ridden by the user. The position of the wearing means 5 with respect to the bicycle varies with the user's riding posture, so that a position measuring value is sensed by each position sensing means 17 in advance and a front-viewing photo of the bicycle 3 ridden by the user is taken by the user or any other person and computed by a computer to obtain the front projecting area of the user's riding posture, so that the position sensing means 17 senses the position measuring value, and the corresponding front projecting area A can be obtained immediately.

The componential force f_{d} of the gravitational force of the bicycle 3 and the user in the traveling direction of the bicycle 3 is expressed in Mathematical Equation 4 below:

f_{d}=mg sin θ (Mathematical Equation 4)

S002: The total force F_{T} of the Mathematical Equation 1 is further expressed in the Mathematical Equation 5 below:

$${f}_{a} + {C}_{F} ( V ) mg cos θ + \frac{ρ {V}_{w}^{2} \cdot A \cdot {C}_{d}}{2} + mg sin θ = ma \qquad ( Mathematical Equation 5 )$$

Where, the force fₐ applied to the bicycle 3 by the user, the air resistance coefficient C_{d} and the rolling friction coefficient C_{F}(V) of the tire 31 of the bicycle 3 are still unknown, so that one of the front projecting areas A is fixed, so that the force fₐ applied to the bicycle 3 by the user is 0 provided that the bicycle 3 slides naturally, and the user has not applied a force to the bicycle 3. In such conditions, the Mathematical Equation 5 may be expressed as the Mathematical Equation 6 below:

$${C}_{F} ( V ) mg cos θ + \frac{ρ {V}_{w}^{2} \cdot A \cdot {C}_{d}}{2} + mg sin θ = ma \qquad ( Mathematical Equation 6 )$$

The traveling speed value V of the naturally sliding bicycle 3 is just affected directly by the friction force f_{b} and the air resistance f_{c} to produce a change of the traveling speed value V. Provided that there is a change of the traveling speed value V measured by the sensor 1, and assumed that an air resistance coefficient C_{d} is a constant, the sensed data are substituted into Mathematical Equation 6, and simultaneous equations of the Mathematical Equation 6 are obtained from different traveling speed values V, and the processing unit 21 calculates the air resistance coefficient C_{d} and a rolling friction coefficient C_{F}(V) of the tire 31 of the bicycle 3 from the simultaneous equation.

S003: The processing unit 21 substitutes the air resistance coefficient C_{d} and the rolling friction coefficient C_{F}(V) into the Mathematical Equation 5 to obtain the force fₐ applied to the bicycle 3 by the user, and the motion power of the force fₐ applied to the bicycle 3 by the user is defined by the product fₐV of the force fₐ and the traveling speed value V.

In a preferred embodiment as shown in FIGS. 2 and 4, the computing means 2 further comprises a display unit 22 and a storage unit 23, and the display unit 22 and the storage unit 23 are coupled to the processing unit 21, and the display unit 22 is provided for displaying the data sensed by the sensor 1 and the computation result of the processing unit 21. The computation result of the processing unit 21 includes the air resistance coefficient C_{d}, the rolling friction coefficient C_{F}(V), the force fₐ applied to the bicycle 3 by the user, and the motion power fₐV, so that the user knows about the riding condition to adjust the riding posture, so as to reduce the air resistance f_{c} and improve the riding efficiency. Preferably, the computing means 2 is a Smartphone installed at the front end of the bicycle 3 to facilitate the user to observe the information displayed on the display unit 22. The storage unit 23 is provided for storing the data sensed by the sensor 1 and the computation result of the processing unit 21 at every time point, so that the user may review the riding conditions at a certain time point anytime.

In a preferred embodiment, the sensor 1 is connected to the computing means 2 via a Bluetooth, Bluetooth Low Energy (BLE), Global System for Mobile Communications (GSM), Wireless Fidelity (WiFi) or ANT+ wireless communication, and the sensor 1 may be installed at any appropriate position of the bicycle 3 to facilitate the user to measure the sensed data.

In summation of the description above, the technical measures disclosed in the present invention overcome the drawbacks of the prior art and achieve the expected objectives and effects. In addition, the present invention has not been published or disclosed publicly prior to filing the patent application, and the invention complies with the patent application requirements, and is submitted to the Patent and Trademark Office for review and granting of the commensurate patent rights.

While the invention has been described by means of specific embodiments, numerous modifications and variations could be made thereto by those skilled in the art without departing from the scope and spirit of the invention set forth in the claims.

What is claimed is:

1. A method of measuring a motion power and a resistance coefficient of a bicycle, comprising the steps of:
connecting a sensor to a processing unit of a computing means, and the sensor measuring or inputting a plurality of sensed data to be transmitted to the processing unit, and the sensed data including: at least one front projecting area A of a bicycle ridden by a user, an air density value ρ, a traveling speed value V and an acceleration value a of the bicycle, a relative wind speed value V_{w} while the bicycle is traveling, an inclination value θ of a road surface where the bicycle is ridden, and a total weight value m of the bicycle and the user; and
fixing one of the front projecting areas A, and calculating the air resistance coefficient C_{d} and a rolling friction coefficient C_{F}(V) of the bicycle tire by substituting the sensed data into Equation 1 through the processing unit, provided that the user has not applied a force to the bicycle and the bicycle slides naturally, such that a change of the traveling speed value V measured by the sensor occurs and assumed that an air resistance coefficient C_{d} is as constant, wherein Equation 1 is expressed as
$${C}_{F} ( V ) mg cos θ + \frac{ρ {V}_{w}^{2} \cdot A \cdot {C}_{d}}{2} + mg sin θ = ma ,$$
where g is a gravitational acceleration value.

2. The method of measuring a motion power and a resistance coefficient of a bicycle as claimed in claim 1, further comprising the step of calculating a force fₐ applied to the bicycle by the user through the processing unit by Equation 2, provided that the user has applied the force to the bicycle, wherein Equation 2 is expressed as
$${f}_{a} + {C}_{F} ( V ) mg cos θ + \frac{ρ {V}_{w}^{2} \cdot A \cdot {C}_{d}}{2} + mg sin θ = ma .$$

3. The method of measuring a motion power and a resistance coefficient of a bicycle as claimed in claim 2, further comprising the step of calculating a user's motion power by the product of the force fₐ applied to the bicycle by the user and the traveling speed value V through the processing unit.

4. The method of measuring a motion power and a resistance coefficient of a bicycle as claimed in claim 1, further comprising the steps of:
installing a position sensing means included in the sensor through a wearing means, wherein a position measuring value sensed by each position sensing means is corresponsive to the respective front projecting area; and
obtaining the front projecting area by the position measuring value sensed by the position sensing means provided that the user is wearing the wearing means.

5. The method of measuring a motion power and a resistance coefficient of a bicycle as claimed in claim 4, wherein the wearing means is a bicycle helmet.

6. The method of measuring a motion power and a resistance coefficient of a bicycle as claimed in claim 1, wherein the sensor further comprises an image capturing means installed at a front end of the bicycle for capturing a front-viewing image of the user and the bicycle, and the processing unit calculates the front projecting area.

7. The method of measuring a motion power and a resistance coefficient of a bicycle as claimed in claim 1, wherein the sensor further comprises a temperature measuring unit and a pressure measuring unit for measuring or inputting the sensed data including an air temperature value and an air pressure value, and the processing unit calculates the air density value by the air temperature value and the air pressure value.

8. The method of measuring a motion power and a resistance coefficient of a bicycle as claimed in claim 1, wherein the sensor further comprises a speed sensor, an anemometer and a level meter, and the speed sensor is provided for measuring the traveling speed value and the acceleration value, and the anemometer is provided for measuring the relative wind speed value, and the level meter is provided for measuring the inclination value.

9. The method of measuring a motion power and a resistance coefficient of a bicycle as claimed in claim 1, wherein the sensor is connected to the computing means through Bluetooth, Bluetooth Low Energy (BLE), Global System for Mobile Communications (GSM), Wireless Fidelity (WiFi) or ANT+ wireless communication.

10. The method of measuring a motion power and a resistance coefficient of a bicycle as claimed in claim 1, wherein the computing means further comprises a display unit and a storage unit, both coupled to the processing unit, and the display unit is provided for displaying the data sensed by the sensor and the computation result of the processing unit, and the storage unit is provided for storing the data sensed by the sensor and the computation result of the processing unit at each time point.
